(19) United States
(12) Patent Application Publication
(10) Pub. No.: US 2009/0278638 A1
(43) Pub. Date: Nov. 12, 2009

(54) Control Device Comprising Means for Indexing the Position of the Control Means

(75) Inventors: Pierre Giroud, Valence (FR); Denis Flandin, Saint Vincent la Commanderie (FR)

Correspondence Address: STEPTOE & JOHNSON LLP, 1330 CONNECTICUT AVENUE, N.W., WASHINGTON, DC, 20036, US

(73) Assignee: CROUZET, VALENCE (FR)

(21) Appl. No.: 12/085,454

(22) PCT Filed: Nov. 23, 2006
(86) PCT No.: PCT/FR2006/002570

§ 371 Date: May 23, 2008

(30) Foreign Application Priority Data
Nov. 24, 2005 (FR) 0511897

(51) Int. Cl. H01H 9/00

(52) U.S. Cl. 335/205

(57) ABSTRACT

Control device comprising a manual control member connected to control means designed to send control orders and comprising first means for indexing the position of said manual control member. The first means for indexing comprise at least one magnetized magnetic element comprising at least one of the magnetic poles having a circumference cut such as to form a first notched profile, and comprises a ferromagnetic indexing support comprising at least one second notched profile. Said respective notched profiles of the magnetized magnetic element and of the indexing support are designed to be placed facing one another so that a magnetic flux flowing between said magnetized magnetic element and said indexing support varies in the course of movement of the manual control means.

### BACKGROUND OF THE INVENTION

The invention relates to a control device comprising a manual control member connected to control means designed to send control orders, and comprising first means for indexing the position of said manual control member.

### STATE OF THE PRIOR ART

The use of control devices comprising a manual control member is widespread, in particular for aeronautical applications such as control handles for airplanes or helicopters. This type of control device is also to be found in the automobile industry, in computers or in handling or hoisting applications.

Numerous patents describe control devices where a control lever comprises one or more degrees of freedom. Swivelling or rotation of the control lever enables in particular a control order to be sent.

The control devices can generally comprise one or more means for detecting the movements of the control lever. The means for detecting notably comprise Hall effect sensors associated with permanent magnets or coil-based inductive systems.

Furthermore, the control devices can also comprise means for indexing the position of the control means. The means for indexing enable the user to have a tactile feedback of the control lever position. The means for indexing are more particularly associated with rotary movement of the control lever.

Existing solutions as presented in the Patents FR2392479 and FR2495373 use one or more mobile plungers operating in collaboration with notches placed in a body. Ball and spring assemblies can also be found. These solutions present in particular the drawback of being noisy on account of the movement of the plunger against the notches. Patent application FR2654898 proposes a less noisy solution than the previous ones but which requires the presence of additional parts.

In a general manner, all these mechanical solutions present a reduced endurance as the moving parts can in particular break after a certain number of uses or cyclic stressings. In addition, the presence of contacts between different mechanical parts introduces frictions that may be detrimental to the movement of the control levers.

The solutions of the Patent applications FR2804240, FR1167718 and U.S. Pat. No. 3,458,840 describe the use of two concentric multipole magnetic crowns. When the user turns the control knob or lever, the magnetic poles of the inner and outer crown come to face one another. The tactile effect felt by the user is close to what would be obtained by notches or cams. The tactile effect is the result of the repulsion and/or attraction of the facing magnetic poles.

The magnetic poles of the crowns of the documents FR2804240 and FR1167718 are made from sintered magnetic material. The crowns are magnetized so as to alternately form north poles and south poles on the facing surfaces. The magnetic crown described in the document U.S. Pat. No. 3,458,840 is composed of a circular body whereon a certain number of magnets are fixed. Due to the relative complexity of the crowns and whatever the solution chosen to achieve the latter, manufacturing thereof is relatively complex and onerous.

The solution U.S. Pat. No. 6,182,370 describes a control device with magnetic indexing means equipped with a permanent magnet the poles whereof are arranged in the axial direction. When this type of indexing means is used in conjunction with means for detecting the position of the control device, the permanent magnet cannot be used for detecting rotary movement. Additional means have to be provided.

The solution FR2698720 describes a variety of magnetic indexing principles that do not allow analog detection of a rotary movement, let alone combined with detection of translation along the same axis.

Finally the current means may present fairly large dimensions.

### SUMMARY OF THE INVENTION

The object of the invention is therefore to remedy the drawbacks of the state of the art so as to propose a control device comprising indexing means.

The control device according to the invention comprises first indexing means comprising at least one magnetized magnetic element comprising at least one of the magnetic poles having a circumference cut in such a way as to form a first notched profile and comprising a ferromagnetic indexing support comprising at least one second notched profile. Said respective notched profiles of the magnetized magnetic element and of the indexing support are designed to be placed facing one another so that a magnetic flux flowing between said magnetized magnetic element and said indexing support varies in the course of movement of the manual control means.

Advantageously, the magnetic flux varies between two values, a maximum value where at least one notch of the magnetized magnetic element is positioned facing at least one notch of the indexing support and a minimum value where at least one notch of the magnetized magnetic element is positioned facing at least one recess of the indexing support.

Preferably, each magnetic pole of the magnetized magnetic element comprises a circumference cut in such a way as to form a notched profile, said notched profiles of the magnetic poles being designed to be placed respectively facing at least one notched profile of the ferromagnetic indexing support.

According to one mode of development of the invention, the indexing support comprises at least two notched profiles designed to be respectively placed facing the notched profiles of the magnetic poles.

Preferably, the indexing support is composed of a circular crown.

Advantageously, said at least one notched profile of the ferromagnetic indexing support is arranged on the external circumference of the crown.

Advantageously, said at least one notched profile of the ferromagnetic indexing support is arranged on the internal circumference of the crown, the magnetized magnetic element placed inside said crown being driven in rotation by the manual control means.

Advantageously, the notched profiles of the magnetized magnetic element are substantially identical to the notched profiles of the ferromagnetic indexing support.

According to one mode of development of the invention, the magnetized magnetic element guided in translation is designed to be attracted by a ferromagnetic zone of a flange, translation of the manual control means causing that of said magnetized magnetic element.

Advantageously, elastic means exert a repulsive force opposing attraction of the magnetized magnetic element by a ferromagnetic zone of the flange.

In a particular embodiment, the control means comprise first means for detecting magnetic field variations of the magnetized magnetic element.

Advantageously, the first means for detecting comprise at least one magnetic sensor designed to detect the magnetic field variations due to rotation of the magnetized magnetic element.

Advantageously, the first means for detecting comprise at least one magnetic sensor designed to detect the magnetic field variations due to translation of the magnetized magnetic element.

In a particular embodiment, the control means comprise second means for detecting angular movements of the manual control member.

Advantageously, the second means for detecting comprise at least one magnetic sensor designed to measurer the magnetic field variations of a second magnetized magnetic element.

### BRIEF DESCRIPTION OF THE DRAWINGS

Other advantages and features will become more clearly apparent from the following description of particular embodiments of the invention, given as non-restrictive examples only and represented in the accompanying drawings in which:

FIG. 1 represents a detailed perspective view of a control device according to a first preferred embodiment of the invention;

FIG. 2 represents a detailed perspective view of a control device according to a second preferred embodiment of the invention;

FIG. 3 represents a detailed perspective view of a control device in a control position according to FIG. 2;

FIG. 4 represents a detailed perspective view of a control device according to a third preferred embodiment of the invention;

FIG. 5 represents a detailed perspective view of a control device in a control position according to FIG. 4;

FIG. 6 represents an overall perspective view of a control device according to FIGS. 1 to 5;

FIGS. 7 and 8 represent a variant of the embodiments of the invention according to FIGS. 1 to 5.

### DETAILED DESCRIPTION OF AN EMBODIMENT

The control device 1 comprises a manual control member 2 designed to be operated by a user.

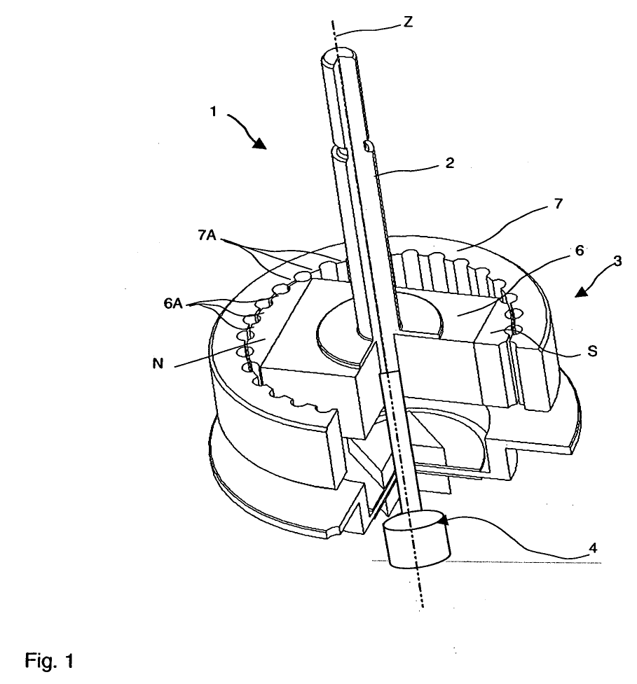

In a first preferred embodiment of the invention as represented in FIG. 1, this manual control member 2 is designed to be directly connected to mechanical control means 4 such as a sprocket system and/or a worm screw, which is not represented.

The control device 1 comprises first means for indexing movement of the manual control member 2 in a plane XY. These means for indexing enable the user to feel a tactile effect in each indexing position associated with sending of a control order.

As represented in FIG. 1, the means for indexing 3 comprise at least one first magnetized magnetic element 6. At least one of the magnetic poles (N, S) of said magnetized magnetic element has a circumference cut in such a way as to form a first notched profile. The means for indexing 3 also comprise at least one ferromagnetic indexing support 7 comprising a portion having a second notched profile. Said respective notched profiles of the magnetized magnetic element 6 and of the indexing support 7 are substantially identical so as to collaborate in the course of movement of the manual control member 2.

In at least one position of the manual control member 2, at least one of the notches 6A of the magnetized magnetic element 6 is respectively facing a notch 7A of the indexing support 7. The magnetic flux from the magnetized magnetic element 6 can then flow to the indexing support 7 via at least one pair of notches 6A, 7A.

The notches 6A, 7A of the magnetized magnetic element 6 and of the indexing support 7 are not however in direct contact. An air-gap exists between the notches 7A of the indexing support 7 and the notches 6A of the magnetized magnetic element 6. This air-gap on the one hand prevents any friction when movements of the magnetized magnetic element 6 and of the indexing support 7 take place, and on the other hand enables the magnetic flux to flow from the first magnetized magnetic element to the indexing support.

In this embodiment, the magnetized magnetic element 6 is connected to the manual control member 2. Thus, rotation of the manual control member 2 around an axis Z causes rotation of the magnetic poles N, S of the magnetized magnetic element 6 around the same axis Z.

According to one embodiment, each magnetic pole N, S of the magnetized magnetic element 6 comprises a circumference cut according to the same notched profile. Said notched profiles of the magnetic poles N, S are designed to operate in conjunction respectively with said at least one notched profile of the ferromagnetic indexing support 7. In the embodiment, due to the rotation of the magnetic poles N, S of the magnetized magnetic element 6 around the axis Z, the indexing support 7 comprises a notched profile of circular shape arranged on a crown. The magnetized magnetic element 6 is placed inside said crown the notches whereof are arranged on an internal circumference. A periodic distribution of the notches 7A is thus observed on the internal profile of the crown 7. The longitudinal axis of the crown 7 is substantially identical to the axis of rotation Z of the magnetized magnetic element 6. This periodic distribution of the notches of the indexing support is substantially identical to the periodic distribution of the notches 6A observed on the magnetic poles of the magnetized magnetic element 6.

When the notches 6A of the magnetic poles of the magnetized magnetic element 6 are located facing notches 7A of the indexing support, the means for indexing 3 are in a stable state. A maximum magnetic flux flows between said magnetized magnetic element and said indexing support. The magnetized magnetic element 6 and the indexing support 7 are kept in place with respect to one another by a magnetic attraction force which is then maximal.

According to this configuration where the indexing support comprises a crown having a notched profile, loops of the magnetic field of said magnetized magnetic element can reclose via the notches 6A of the magnetic North pole operating in conjunction with the first notches 7A of the indexing support 7, the notches 6A of the magnetic South pole operating in conjunction with the second notches 7A of the indexing support 7 and by the ferromagnetic structure of the indexing support 7.

As soon as a movement of the magnetized magnetic element 6 is observed, the notches 6A, 7A of said magnetized magnetic element and of the support will no longer be totally facing one another. A stagger exists between said notches.

In a first part of the movement, the magnetic flux between the magnetized magnetic element 6 and the indexing support 7 tends to decrease to reach a minimum value when the notches 6A of the magnetized magnetic element 6 are respectively facing a recess of the notched profile of the indexing support 7. In this first part of the movement, as the magnetic system seeks to maximize the magnetic flux between the magnetized magnetic element 6 and the indexing support 7, a restoring torque around the axis Z tends to oppose the movement.

In a second part of the movement, the magnetic flux between the magnetized magnetic element 6 and the indexing support 7 tends to increase to reach a maximum value when all the notches 6A of said magnetized magnetic element are facing a notch 7A of the notched profile of said indexing support. In this second part of the movement, as the magnetic seeks to maximize the magnetic flux between the magnetized magnetic element 6 and the indexing support 7, a restoring torque around the axis Z tends to enhance the movement.

Thus, in the first part of the movement, the user feels an opposition to his action then this opposition suddenly stops and is transformed into assistance in moving. This tactile effect can in particular be felt each time a notch of the magnetized magnetic element 6 facing a notch of the indexing support 7 is passed.

The number of notches 7A and the arrangement of said notches on the indexing support 7 condition the number of indexing steps and therefore the number of tactile effects felt by the user turning the manual control member 2 along the axis Z.

For example, the magnetized magnetic element 6 comprises a permanent magnet on which two magnetic parts are added. The magnetic parts respectively placed on each of the poles of the magnet then comprise a notched profile. Other embodiments can be envisaged to achieve the magnetized magnetic element 6. Said element magnetic can in particular comprise a permanent magnet the poles whereof are shaped in the form of a notched profile as described above.

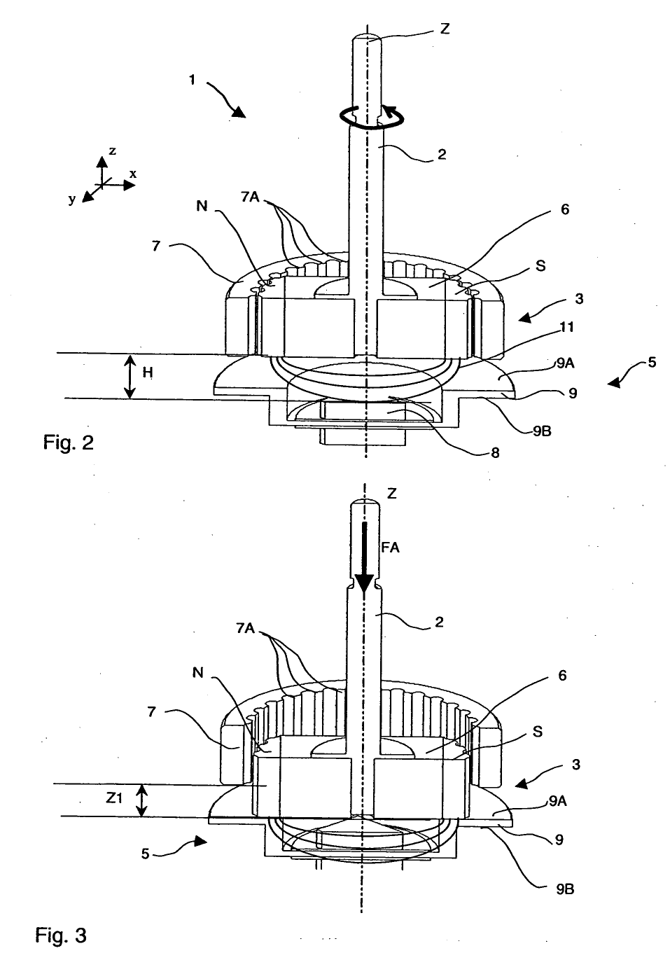

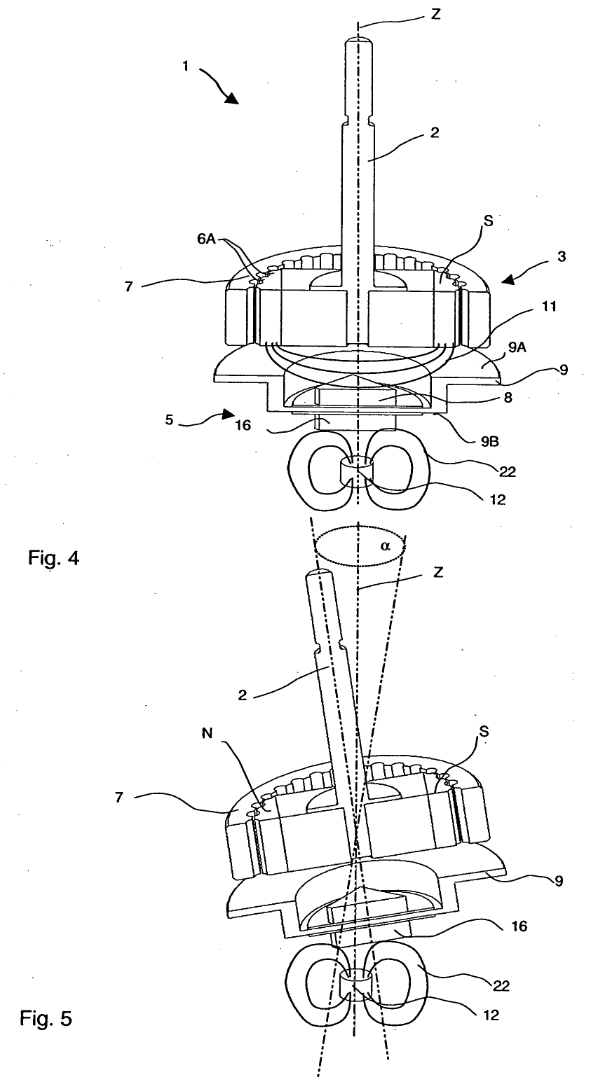

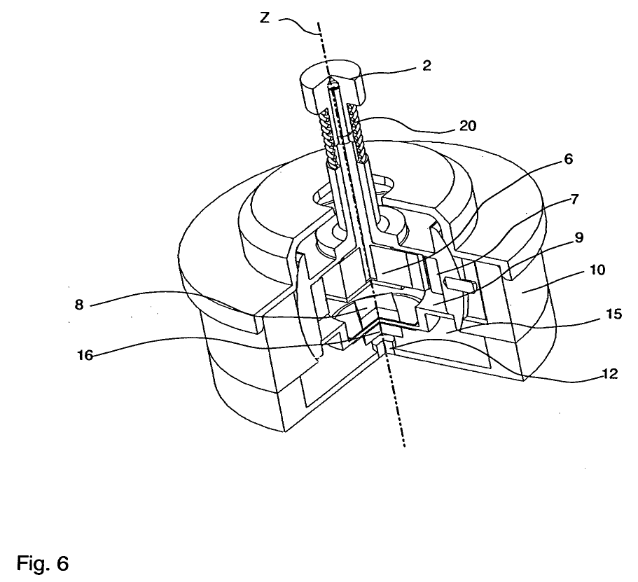

According to a second preferred embodiment of the invention as represented in FIG. 2, the manual control member 2 can be connected to electric control means 5. The electric control means 5 comprise first detection means 8 designed to detect movement of the manual control member 2 in at least one direction. These detection means 5 are connected to processing means, not represented, that can in particular send a control order.

As represented in FIG. 2, first detection means 8 detecting movement of the magnetized magnetic element 6 are positioned near to said magnetized magnetic element. In the embodiment example, the first detection means 8 comprise a magnetic sensor placed substantially on the axis of rotation Z of the magnetized magnetic element 6 at a distance H. In practice, the first detection means 8 are positioned on a first face 9A of a shielding flange 9. The flange 9, which is preferably cylindrical, comprises a longitudinal axis that is substantially identical to the longitudinal axis of the control member 2.

In this embodiment, the manual control member 2 does not drive the shielding flange 9 in rotation around the axis Z, the latter being connected to the indexing support 7.

In this arrangement, the fixed magnetic sensor of the first detection means 8 detects the variations of the magnetic field 11 of the permanent magnetized magnetic element 6 in rotation around the longitudinal axis Z. The first detection means 8 are thereby able to supply positioning information of the manual control member 2 in rotation around the axis Z. An item of positioning information can in particular be associated with each indexing pitch.

Moreover, as represented in FIG. 3, said first detection means can also detect the translation movement of the manual control member 2 along the axis Z. The first detection means then detect the variations of the magnetic field 11 of the magnetized magnetic element 6 in translation along the longitudinal axis Z. The manual control member 2 can move over a distance Z1 due to the action of a manual actuating force FA.

Elastic means 20 keep the magnetized magnetic element 6 separated from the first detection means 8 by exerting a repulsive force. The repulsive force then tends to oppose the action of a manual actuating force FA. To move the manual control member 2, the manual actuating force FA is greater than the repulsive force of the elastic means 20. Due to the action of the manual actuating force FA, the distance H tends to decrease and the magnetic field 11 measured by the first detection means 8 varies. This magnetic field variation is interpreted by processing means, which are not represented.

In addition, in the course of movement of the magnetized magnetic element 6 in the direction of the first detection means 8 along the axis Z, said magnetized magnetic element is attracted by a ferromagnetic zone placed on the first face 9a of the flange 9. The magnetic attraction force between the magnetized magnetic element 6 and the ferromagnetic zone of the shielding flange 9 increases more quickly than the repulsive force of the elastic means 20. Thus, beyond a certain movement along the axis Z, the magnetized magnetic element abruptly sticks onto the ferromagnetic zone of the flange 9. The user then feels a tactile perception called swivelling perception. The magnetized magnetic element 6 and the ferromagnetic zone of the flange 9 then form second means for indexing the movement of the manual control member 2 along the axis Z. These second means for indexing comprise a single indexing step.

In this way, on each validation of a control order sent by applying an actuating force FA to the manual control member 2, the user perceives a tactile effect in this control direction Z.

In the course of rotation or translation of the manual control member 2, the longitudinal axis of the manual control member 2 remains identical to the axis Z.

The permanent magnetized magnetic element 6 therefore has three distinct functions. Firstly, it forms an integral part of the first means for indexing 3 rotation of the manual control member around the axis Z. Secondly, it forms an integral part of the first detection means 8. And finally, thirdly, it forms an integral part of the second means for indexing translation of the manual control member 2 along the axis Z.

According to a third preferred embodiment of the invention, the manual control member 2 comprises a first end connected to the enclosure 10 by a knuckle-joint and comprises a second end designed to perform a rotation with respect to the first end by moving along at least one control direction. The alignment of the two ends defines a longitudinal axis of the manual control member 2.

The control device 1 comprises second detection means 16 detecting the solid angular movements α of the longitudinal axis of the manual control member 2 with respect to the axis Z. In other words, the second detection means 16 are designed to detect movement of the second end of the manual control member in a direction of the plane XY. As represented in FIG. 5, the longitudinal axis of the manual control member 2 can in fact perform a rotation around the axis Z after it has made an angular movement α.

The second detection means 16 composed of at least one magnetic sensor are designed to measure the variations of a magnetic field 22 produced by a second magnetized magnetic element 12.

According to this embodiment, the second magnetized magnetic element 12 is fixed onto the enclosure 10 of the control device 1 and is immobile with respect to the manual control member 2. The magnetic sensor of the second detection means 16 is positioned on a second face 9B of the shielding flange 9. Angular movement of the longitudinal axis of the manual control member 2 with respect to the axis Z causes angular movement of the shielding flange 9. The magnetic sensor 16 is then mobile with respect to the magnetized magnetic element 12.

According to another embodiment, the magnetic sensor could be fixed and the magnetized magnetic element be mobile. The magnetic sensor would then be connected to the enclosure 10 whereas the magnetized magnetic element 12 would move with the manual control member 2.

On account of the respective positioning of the two magnetized magnetic elements 6, 12 on the faces of the shielding flange 9, there is no magnetic interaction between the magnetic fields 11, 22 produced by the two magnetized magnetic elements 6, 12. This shielding flange 9 thus delineates two independent magnetic zones. The magnetic sensor of the first detection means 8 does not detect the variations of the magnetic field 22 of the second magnetized magnetic element 12 and reciprocally the magnetic sensor of the second detection means 16 does not detect the variations of the magnetic field 11 of the first magnetized magnetic element 6.

When the control device is not used, a return spring, not represented, enables the longitudinal axis of the manual control member 2 to be aligned with the axis Z.

According to an alternative embodiment, the control device 1 comprises a connecting plate 90 connected to the control lever 2 by means of a sliding knuckle-joint connection. The connecting plate 90 comprises a first bearing face 91 in contact with a bearing zone of the control lever 2. The connecting plate 90 comprises a second bearing face 92 in contact with the enclosure 10 by means of elastic securing means 100. According to this embodiment of the invention, the connecting plate 90 is in the shape of a disk.

The elastic securing means 100 are preferably composed of an elastic washer. This washer comprises a first radial face pressing on the enclosure 10. This washer comprises a second face pressing on the second bearing face 92 of the connecting plate 90. The elastic means 100 then exert a holding force tending to keep the first bearing face 91 of the connecting plate 90 in contact against the control lever 2.

The first bearing face 91 comprises at least two contact ramps 93, 95. In this embodiment, said ramps are composed of flat portions respectively having the shape of a flat ring. An inflection point is observed between the second ramp 95 and the first ramp 93. In addition, according to this embodiment, the rings are concentric.

The bearing zone of the control lever 2 comprises at least one protuberance 21 in contact with at least one of the ramps of the first bearing face 91.

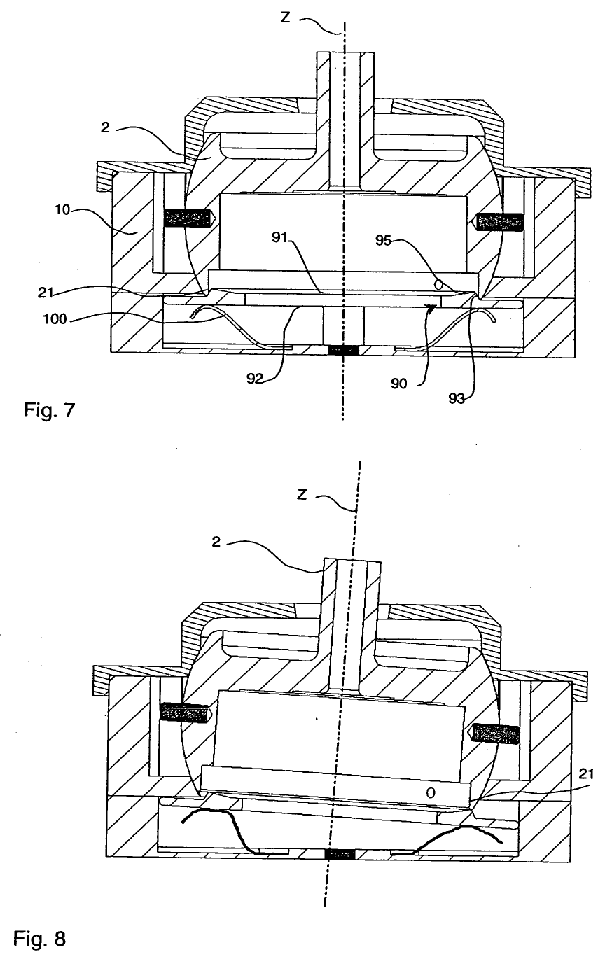

Operation of the control device is as follows. When the control lever 2 is at rest, as represented in FIG. 7, the holding force exerted by the elastic means 100 keeps said at least one protuberance 21 in contact with the first contact ramp 93.

When the control lever 2 is actuated in one of the control directions, movement of said lever causes movement of said at least one protuberance 21 on the ramps of the first bearing face of the connecting plate 90.

According to the particular embodiment as represented in FIG. 8, movement of the protuberance on the first ramp 93 tends to increase the holding force of the elastic means 100. When the protuberance moves from the first ramp 93 to the second ramp 95, the elastic holding means 100 release sharply and the holding force decreases. The user then feels a tactile perception at the level of the control lever 2. This tactile perception is caused by the protuberance passing the inflection point between the two ramps. At the time said point is passed, the holding force which was increasing in fact decreases abruptly.

The extent to which the tactile perception is felt at the moment the control lever is actuated is conditioned by the angle of incline between the first ramp and the second ramp. Furthermore, the magnitude of the gradient of the holding force when passage from the first ramp 93 to the second ramp 95 takes place is conditioned by the value of the angle of incline. The holding force depends in particular on the stiffness of the spring of the elastic means 100.

According to another alternative embodiment, the first bearing face 91 comprises at least three different contact ramps.

According to another alternative of the embodiments of the invention, the contact ramps 93, 95 can comprise curved profiles in the shape of a portion of circle, an ellipsis or a parabola. The holding force of the elastic holding means 100 then varies according to the curve of said ramps.

1. Control device comprising
a manual control member connected to control means designed to send control orders,
first means for indexing the position of said manual control member,
wherein the first means for indexing comprise
at least one magnetized magnetic element comprising at least one of the magnetic poles having a circumference cut in such a way as to form a first notched profile,
a ferromagnetic indexing support comprising at least one second notched profile, said respective notched profiles of the magnetized magnetic element and of the indexing support being designed to be placed facing one another in such a way that a magnetic flux flowing between said magnetized magnetic element and said indexing support varies in the course of the movement of the manual control means.

2. Control device according to claim 1 wherein the magnetic flux varies between two values,
a maximum value where at least one notch of the magnetized magnetic element is positioned facing at least one notch of the indexing support,
a minimum value where at least one notch of the magnetized magnetic element is positioned facing at least one recess of the indexing support.

3. Control device according to claim 1 wherein each magnetic pole of the magnetized magnetic element comprises a circumference cut in such a way as to form a notched profile, said notched profiles of the magnetic poles being designed to be placed facing at least one notched profile of the ferromagnetic indexing support.

4. Control device according to claim 3 wherein the indexing support comprises at least two notched profiles designed to be placed respectively facing the notched profiles of the magnetic poles.

5. Control device according to claim 3 wherein the indexing support is composed of a circular crown.

6. Control device according to claim 5 wherein said at least one notched profile of the ferromagnetic indexing support is arranged on the external circumference of the crown.

7. Control device according to claim 5 wherein said at least one notched profile of the ferromagnetic indexing support is arranged on the internal circumference of the crown, the magnetized magnetic element placed inside said crown being driven in rotation by the manual control means.

8. Control device according to claim 1 wherein the notched profiles of the magnetized magnetic element are substantially identical to the notched profiles of the ferromagnetic indexing support.

9. Control device according to claim 1 wherein the magnetized magnetic element guided in translation is designed to be attracted by a ferromagnetic zone of a flange, translation of the manual control means causing that of said magnetized magnetic element.

10. Control device according to claim 9 wherein elastic means exert a repulsive force opposing attraction of the magnetized magnetic element by a ferromagnetic zone of the flange.

11. Control device according to claim 1 wherein the control means comprise first detection means detecting variations of the magnetic field of the magnetized magnetic element.

12. Control device according to claim 11 wherein the first detection means comprise at least one magnetic sensor designed to detect variations of the magnetic field due to rotation of the magnetized magnetic element.

13. Control device according to claim 11 wherein the first detection means comprise at least one magnetic sensor designed to detect variations of the magnetic field due to translation of the magnetized magnetic element.

14. Control device according to claim 1 wherein the control means comprise second detection means detecting the angular movements of the manual control member.

15. Control device according to claim 14 characterized in that the second detection means comprise at least one magnetic sensor designed to measure the variations of the magnetic field of a second magnetized magnetic element.
